(19) United States
(12) Patent Application Publication
(10) Pub. No.: US 2006/0248363 A1
(43) Pub. Date: Nov. 2, 2006

(54) Apparatus of dual-monitor portable computer and operational method thereof

(75) Inventors: Jia-Liang Chen, Taipei (TW); Shu-Mai Chang, Taipei (TW); Pao-Chang Lin, Taipei (TW)

Correspondence Address: BACON & THOMAS, PLLC, 625 SLATERS LANE, FOURTH FLOOR, ALEXANDRIA, VA, 22314, US

(73) Assignee: CLEVO CO., Taipei (TW)

(21) Appl. No.: 11/414,224

(22) Filed: May 1, 2006

(30) Foreign Application Priority Data
Apr. 29, 2005 (TW) 94114023

(51) Int. Cl. G06F 1/00

(52) U.S. Cl. 713/300

(57) ABSTRACT

An apparatus of dual-monitor portable computer and operational method thereof is a portable computer with another sub-monitor which is configured on the lid. The sub-monitor can display different menu for the user to determine which functionality shall execute. The apparatus includes at least CPU, north bridge chipset, south bridge chipset, system memory, a first display monitor, coupling to the north bridge chipset, and a secondary display monitor, the sub-monitor coupling to a keyboard controller and a programmable logic controller. The apparatus also includes BIOS and a or plurality of hotkeys, coupling to the keyboard controller, to assist the user's operation.

### BACKGROUND OF THE INVENTION

1. Field of the Invention

The invention provides an apparatus of dual-monitor portable computer and its operational method, especially concerns having a sub-monitor in a portable computer system with primary display monitor.

2. Description of Related Art

The ease of mobility of the portable computer, such as the notebook computer, resulted the mushroomed of its applications. There among the singularity application of the display monitor, such as U.S. Pat. No. 6,532,146, revealed the extension of the primary monitor by adding the other monitor at the both sides of the primary monitor. The moment connections between the monitors enabled the monitors to be shifted to desired position, and allowed the display contents freely move within the monitors.

U.S. Pat. No. 6,574,487 revealed the apparatus of the portable telephone with dual display monitors. By using the display monitors mounted on the both sides of a single PCB, the secondary monitor of the related prior art's portable telephone could displays some simple alert messages, such as incoming call display, alarm, or viewfinder of the camera.

U.S. Pat. No. 6,757,036 revealed the apparatus of the architecture of LCD display monitor, which is applicable to portable cellular phone, laptop computer, PDA, and other applications, which use the LCD display monitor. As shown in FIG. 1, Laptop computer 10 with the lid 12 closed, having a lid monitor 14 configured on top of the lid 12.

US Patent Published Application No. 2004/0183745 further revealed the method to drive two display monitors simultaneously using a single display driver unit.

Most of the current laptop computer only have single display monitor. If there is architecture of the secondary monitor, most of the secondary monitors are mono-color and with smaller size of screen, providing simple messages to the user. The secondary monitor of prior art uses I²C interface, and thus unable to provide more contents.

Consequently, despite of configuring the secondary display monitor, which is connected to the south bridge chipset, current invention also improved the applications of the dual-monitor apparatus by providing the multimedia-based features selection menu on the secondary monitor.

### SUMMARY OF THE INVENTION

An apparatus and operational method of dual-monitor portable computer, which configures a colored secondary monitor on the lid, produces different display functionalities in shutdown mode, multimedia mode, and operating system mode.

The computer apparatus at least comprises Central Processing Unit (CPU), north bridge chipset, which couples to the CPU, system memory, south bridge chipset, primary display monitor, which is connected to the north bridge chipset, secondary display monitor, which is connected to the keyboard controller and programmable logic controller, BIOS, and one or plurality hotkeys, which is coupled to the keyboard controller.

When portable computer enters in the shutdown mode, it immediately powers up some components, and drives one or plurality of external apparatus. Then by mean of the system management bus, the system information of the portable computer can show on the secondary display monitor. The secondary display monitor also displays the functional menu for user to choose.

When the portable computer is powered up but dose not execute the operating system, the portable computer will execute a multimedia mode procedure. The procedure of the multimedia mode includes by means of the keyboard controller to power up some components of the portable computer but to shut down the bus priority of the secondary display monitor. Meanwhile, the keyboard controller also acknowledge CPU and chipset of the portable computer to enter the power save mode. Then, the program from the multimedia memory unit is loaded. And a multimedia functionalities menu is displayed on the display monitor for users to choose which functionality will be executed.

When the portable computer executes a normal mode, it is executing the boot procedure of an operating system. The procedure includes the initialization of the secondary display monitor, the execution of the boot procedure, and the drive of the secondary display monitor. Then, the functionalities menu is displayed on the secondary display monitor for the users to choose which the functionalities will be executed.

### BRIEF DESCRIPTION OF THE DRAWINGS

FIG. 1 illustrates an embodiment of the related prior art.

FIG. 2A and FIG. 2B illustrates the embodiment in accordance with the present invention.

FIG. 3 is the circuitry block diagram in accordance with the present invention.

FIG. 4 is the operation flow chart in shutdown mode in accordance with the present invention.

FIG. 5 illustrates the contents of the secondary display monitor in shutdown mode in accordance to an embodiment of the present invention.

FIG. 6 is the operation flow chart in media mode in accordance with the present invention.

FIG. 7 illustrates the contents of the secondary display monitor in multimedia mode in accordance to an embodiment of the present invention.

FIG. 8 is the operation flow chart in operating system mode in accordance with the present invention.

FIG. 9A and FIG. 9b illustrate the contents of the secondary display monitor in operating system mode in accordance to an embodiment of the present invention.

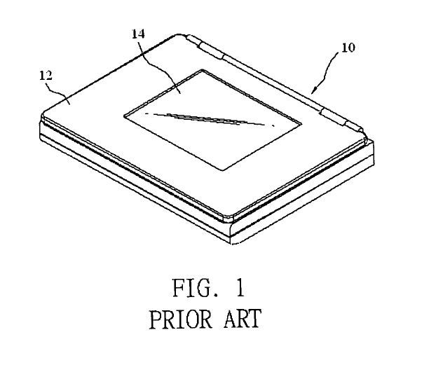

### DESCRIPTION OF THE PREFERRED EMBODIMENTS

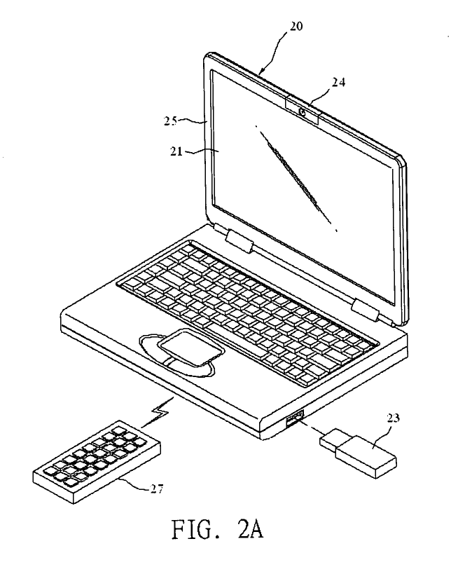

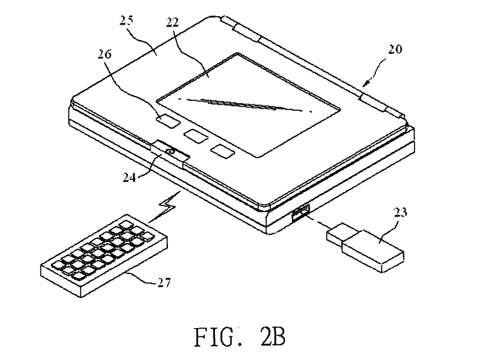

Present invention is an apparatus of a portable computer which is configured plurality of display monitors. FIG. 2A and FIG. 2B illustrate the preferred embodiments of present invention, therein, the portable computer 20 can utilize the external memory device 23 via Universal Serial Bus (USB) interface, such as pen drive, external hard disc, CD-ROM or other memory device. Despite of reading/playing the contents of the external memory devices in the normal operation mode, when the portable computer is in standby mode or even shutdown mode, the contents of the external memory devices 23 can be still displayed on the secondary display monitor 22 by determining of a functionality menu and affiliating with the hotkeys.

Additionally, present portable computer 20 is configured a rotational web cam 24 to take image and show on the primary display 21 or the display monitor 22 as a viewfinder whenever the lid 25 of the portable computer 20 is opened or closed. Also, by means of operating the hotkeys 26 and remote controller 27, the user can choose what the content shall perform in accordance with the determination of the software selections menu.

Therein the skill of present invention by means of the above primary display monitor 21 and secondary display monitor 22 as shown in the embodiments have following feature at least:
(1) Simultaneously displays different pictures and information by using first monitor (as primary monitor 21) and second monitor (as secondary monitor 22).
(2) When the lid 25 of the portable computer 20 is being closed, the secondary monitor 22 can display the functional information such as battery gauge, time, manufacturer's logo and customized figure in accordance with the user's request.
(3) When the portable computer is in shutdown mode, the secondary display monitor 22 can display the information and other multimedia contents, such as pictures, by means of the keyboard controller affiliating with DSP (Digital Signal Processor) or ASIC (Application-Specific Integrated Circuit).
(4) When the portable computer is powered on without executing operating system, such as in multimedia mode, the primary display monitor 21 does not power up, and the CPU and other unnecessary units are in the status of power save mode instructed by BIOS. Nevertheless, the secondary display monitor 22 is powered up for the user to retrieve the information, to operate various multimedia or to play video/audio.
(5) When the portable computer 20 enters in the normal boot procedure, the execution of the operating system will allows the secondary monitor 22 to provide the same the operational functionalities as in shutdown mode or in multimedia mode.

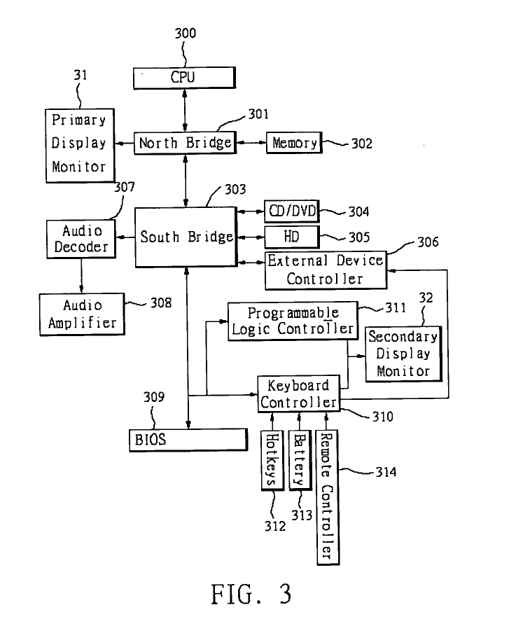

FIG. 3 is the circuitry block diagram of the embodiment in accordance to present invention. The architecture at least includes CPU 300, north bridge chipset 301, which is coupling to the CPU 300, system memory 302 and primary display monitor 31, which are coupling to the north bridge chipset 301. Additionally, there is a south bridge chipset 303 coupling to the north bridge chipset 301. The south bridge chipset 303 controls the signal transmission of the surrounding devices, such as CD-ROM/DVD-ROM 304, HD 305 and other storage media connected through the interface of IDE, ATA, SCSI, or Serial ATA. The south bridge chipset 303 can also connect to various external storage devices via USB (Universal Serial Bus), such as video/audio multimedia devices and other devices through external device controller 306. South bridge chipset 303 also connects to audio decoder 307, and amplifies the audio signal through audio signal amplifier 308. BIOS 309 of the computer system also connects to the south bridge chipset 303 to control the peripherals after the computer system has been powered up.

The application of dual-monitor portable computer of present invention includes 3 modes: shutdown mode, multimedia mode and OS mode. Thus, BIOS 309, which controls the boot process, will need to support these modes. The BIOS 309 and south bridge chipset 303 also connects to the keyboard controller 310 and programmable logic controller 311 such as FPGA (Field Programmable Gate Array) or CPLD (Complex Programmable Logic Device). Therein BIOS 309 connects to the keyboard controller 310 and programmable logic controller 311 via Low-Pin-Count (LPS) bus, and the keyboard controller 310 and programmable logic controller 311 electrically connect to the secondary display monitor 32 of present invention. The preferred embodiment configures a colored monitor on top of the lid of portable computer. A plurality of hotkeys, which are coupling to the keyboard controller 310, are configured near to the secondary display monitor 32. The hotkeys 312 are configured for the users to control the functionalities selection menu on the secondary display monitor 32. Additionally, there are also battery 313, remote receiver 314 and other devices connecting to the keyboard controller 310.

In the embodiment of the present invention, external device controller 306 is coupling to the keyboard controller 310. By means of the hotkeys 312 to control the functionalities selection menu, the secondary display monitor can display music, movie or other multimedia stored in external device via the controller 306.

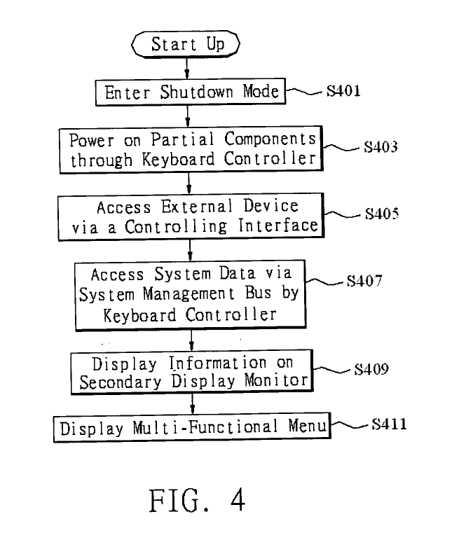

Referring to the apparatus described above, the dual-monitor portable computer of present invention provides three modes including shutdown mode, multimedia mode and normal operating system mode (OS mode). Below are the configuration and operational method of the embodiment:
1. Shutdown mode. Please refer to FIG. 4, Which illustrates the operational flow chart in shutdown mode:
(Step 401) Enter into shutdown mode, wherein the CPU of the portable computer is disable.
(Step 403) Power up partial necessary components of the portable computer through the keyboard controller, such as the secondary display monitor, the external device controller and the audio amplifier.
(Step 405) Access external devices, such as external hard disc, CD-ROM, Pen Drive, MP3 Player and so on via a controlling interface such as UART (Universal Asynchronous Receiver/Transmitter). The external devices mentioned above could be as a card reader or other storage media. The secondary display monitor not only display the multimedia information stored in the external devices, but also provide the functionalities for userd to stop, pause, previous track, next track, volume and mute by the hotkeys.
(Step 407) Read the system information of the portable computer via SMB (System Management Bus) by means of the keyboard controller, such as battery capacity.
(Step 409) Display information on the secondary display monitor, for instance, display the current battery capacity in the status of computer shutdown.
(Step 411) Display multi-functional menu on the secondary display monitor for the user to determine what the function shall execute.

With the consideration of the battery power life, the embodiment of the present invention provides different power schemes, such as AC scheme and battery scheme. In AC scheme, the AC powers up the secondary display monitor via remote controller or hotkeys. Thus, the laptop computer starts operate when the keyboard controller is connected to the power source regardless to the battery life. In battery scheme, the remote controller with remote receiver or hotkeys start operates after the secondary display monitor is being started up through hotkeys. In order to save power, the keyboard controller start operates after the hotkey is being clicked to reduce the power consumption.

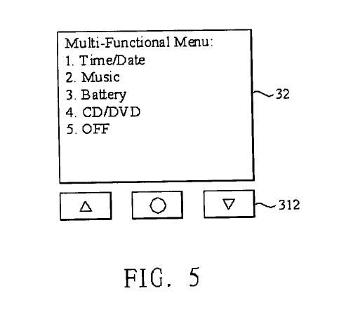

FIG. 5 illustrates the contents of the secondary display monitor 32 in accordance with the embodiment in shutdown mode. The selection menu on the secondary display monitor can be controlled and selected by plurality of hotkeys 312 or remote control.

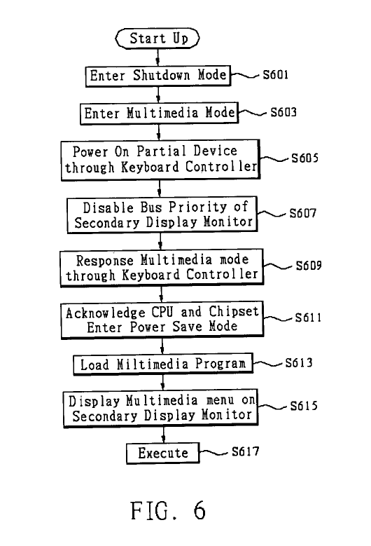

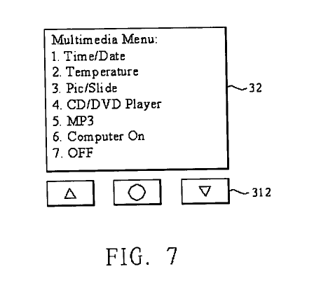

The function of the multi-functional menu illustates on the secondary display monitor in shutdown mode at least comprises (1) Time/Date, provides current time and date for the user without the system boot up; (2) Music, by means of the speaker embeded in the portable computer, the user play music by operating the remote controller or hotkeys when the computer system still in shutdown mode. The music comprises MP3 and other audio compressing format, or CD music; (3) Battery, provides present battery power capacity to the user; (4) CD/DVD, the function for the user palys multimedia, triggers the CPU to enter power save mode. Also, provide and display multimedia functionalities on the secondary display monitor through BIOS, without entering the operating system mode; (5) Power off, shut down the secondary display monitor and other computer power source. This function of power off can be executed by hotkey.
2. Multimedia mode. Please refer to FIG. 6, which illustrates the operational flow chart in multimedia mode:
Media mode boots up the computer without entering the operating system. The boot up flowchart is as below:
(Step 601) After system startup, enter into the shutdown mode mentioned above by hot key.
(Step 603) Enter into multimedia mode by selecting the multi-functional menu in shutdown mode.
(Step 605) Now, the keyboard controller will turn on the power source to power up the related necessary components, such as CPU, north bridge chip, south bridge chip, programmable logic controller, and so on.
(Step 607) Besides, disable the Bus priority of the secondary display monitor through keyboard controller, That is, Some related necessary components of the system should be ready to be controlled by the CPU via BIOS.
(Step 609) Then, BIOS requests keyboard controller to reponse if current system is in normal boot up mode or multimedia mode. In this embodiment, keyboard controller responses the current system with multimedia mode.
(Step 611) Next, BIOS acknowledges CPU and chipset to enter power save mode, and remains the primary display monitor in powered off.
(Step 613) Also, loads and executes the program of a multimedia ROM. The multimedia ROM is configured separately from the BIOS. The purpose of the program in the multimedia ROM is to allow the system to display the information on the secondary display monitor via programmable logic controller, which is connected on the LPC bus. Therein, the better embodiment at least provides the multimedia menu as following (Step 615) for the users to determine which function shall be executed from the content of the multimedia menu (Step 617). The multimedia menu is as shown in FIG. 7:
(1) Time/Date. This function is to read BIOS time and date by means of the program in BIOS 309, and to display the data on the secondary display monitor 32, when the system is in multimedia mode.
(2) Temperature. By means of the program in BIOS 309 and the keyboard controller 310, the secondary display monitor 32 can displayed the temperature of the system, when the system is in multimedia mode.
(3) Pic/Slide show. When the system is in multimedia mode, through the applications in the operating system, such as Windows, Linux, Macintosh, the program in BIOS 309 save the pictures and its information into an assigned memory, such as the unused address in BIOS 309, the FLASH configured by the system, or external memory devices. The pictures and its information can be displayed on the secondary display monitor 32, when the BIOS 309 enters the multimedia mode.
(4) CD/DVD player. When the system is in multimedia mode, the function will play the music CD/DVD through build in CD/DVD ROM, and also display the music information on the secondary display monitor 32. When the function of CD/DVD player is selected, BIOS 309 will initialize the I/O interface of the Hard Disc, and call for the interrupt service. Next, BIOS 309 will read the fixed specific sector of the Hard Disc 305, and loads the program into a specific allocated memory, and also calls the play CD/DVD application. Through the application of the operating system, the specific allocated sector of the Hard Disc initializes the CD ROM 304 and audio decoder 307 as shown in FIG. 3, in order to provide the functionality of audio CD/DVD player, and the functionality to display the information on the secondary display monitor 32.
(5) MP3. When the system is in multimedia mode, the function plays the compressed music format, MP3, which is saved in the build in Hard Disc 305 or CD ROM 304. The function also displays the information of MP3 on the secondary display monitor 32. Therein the CD ROM 304 and the audio decoder 307 as shown in FIG. 3 need to be initialized through the application of the operating system.
(6) Computer On. The function provides the user to switch the portable computer into the normal boot up mode from the multimedia mode.
(7) Off. The function provides the user to shut down the system in multimedia mode.

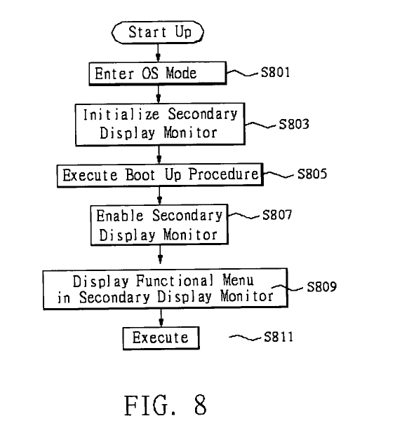

In the above media mode, the menu and functionalities above can be operated by using remote controller and hotkey 312.
3. Operating system mode. Please refer to FIG. 8, which illustrates the operational flow chart in operating system (OS) mode:
(Step 801) After the system startup, the user decides to enter the OS mode.
(Step 803) When the OS mode is determined, BIOS 309 calls for OS program and executes normal boot up mode. Then, BIOS 309 resets and initializes secondary display monitor 32. Through the initialization, the monitors can display the computer system manufacturer, dealer's logo or advertising animation.
(Step 805) As Step 803, the system will execute the OS procedure to boot up the portable computer, such as initializing the surrounding devices by BIOS, POST and other procedures, to execute as in normal OS mode.
(Step 807) Enable the secondary display monitor. In order to operate the secondary display monitor 32, the related application and the driver program for the particular operating system must be installed. The driver program can be automatically loaded every time the operating system is launched, or can be executed individually.
(Step 809) Display a functional menu in the secondary monitor. When the secondary display monitor 32 is utilized, it provide the user the functional menu to determine which function shall be execute. (Step 811)

After entering OS mode, there are two modes still. One is an LID open mode and the other is an LID close mode. Due to the secondary display monitor 32 is smaller comparing to the primary display monitor 31, it provides less functionality in the LID open mode. Otherwise, in LID close mode, in contrast, the secondary display monitor provides more functionality comaparing to itself in open mode. When entering the operating system, if the program detects the lid is in close mode, the system will disable some unnecessary components or some peripherals for power saving.

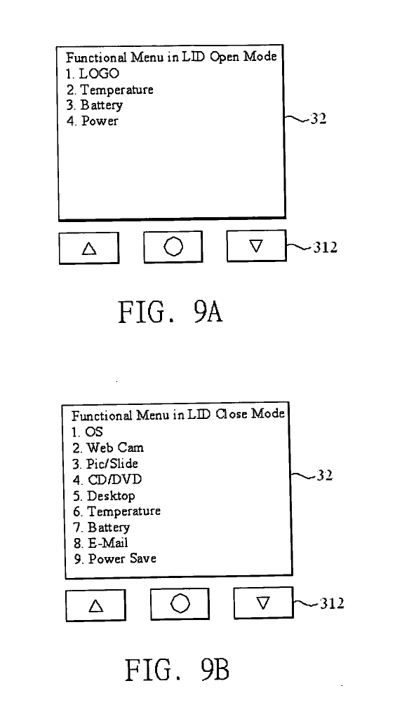

The functional selection in LID open mode is as below, as shown in FIG. 9a:
(1) Logo. the secondary display monitor displays system default information such as product manufacturer's logo, user's photo, scenery picture and so on.
(2) Temperature. When this function is selected, the secondary display monitor displays the degree of the CPU temperature BIOS.
(3) Battery gauge. When this function is selected, the secondary display monitor displays the battery status of the portable computer via BIOS.
(4) Power save mode. When this function is selected, application will shut down the secondary display monitor through drivers.

The functional selection in LID close mode is as below, as shown in FIG. 9b:
(1) OS. When this function is selected, the BIOS and the surrounding devices information can be retrieved, such as the current time and date, WLAN/Bluetooth/IrDA signal level, Web Cam status. The information and the wallpaper can be displayed on the secondary display monitor based on the needs.
(2) Web cam. This function is selected in LID close mode. Therein the web cam on the portable computer can be used as video recorder or camera, and the secondary display monitor can be used as viewfinder. The video and picture can be saved and displayed on the secondary display monitor.
(3) Pic/Slide show, in LID close mode, the selected logo or pictures can be displayed on the secondary display monitor in the mode of picture or slide alternative.
(4) CD/DVD player. When this function is selected, CD/DVD audio/video or various compressed format music, such as MP3, AVI, MPEG can be played using the multimedia player of the operating system, such as Media player, Real player. The multimedia can be displayed on the secondary display monitor.
(5) Desktop. This function displays the information and status of operating system, generally speaking, desktop, on the secondary display monitor.
(6) Temperature. This function displays the current temperature of the computer system and environment on the secondary display monitor.
(7) Battery gauge. This function displays the battery status of the portable computer on the secondary display monitor.
(8) Email notification. This function allows the secondary display monitor communicates with the operating system email application through software/hardware interface, such as API, FPGA, and displays the inbox information on the secondary display monitor.
(9) Power save. When this function is selected, the secondary display monitor will be shut down to enter power save mode by the application via driver.

The above figures, which described the present invention is only for reference and illustration, and it's not the limitation for the present invention.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. An apparatus of dual monitor portable computer having a colorful secondary display monitor embedded on the lid of said portable computer, comprising:
a CPU;
a north bridge chipset, coupling to said CPU;
a system memory, coupling to said north bridge chipset;
a primary display monitor, coupling to said north bridge chipset;
a south bridge chipset, coupling to said north bridge chipset;
a BIOS, coupling to said south bridge chipset;
a keyboard controller, coupling to said BIOS and said south bridge chipset;
a programmable logic controller, coupling to said BIOS and said south bridge chipset;
said secondary display monitor, coupling to said keyboard controller and said programmable logic controller; and
one or plurality of hotkeys, coupling to said keyboard controller, and configured nearby said secondary display monitor.

2. The apparatus of dual monitor portable computer as set forth in claim 1, comprising an external device controller coupling to said south bridge chipset.

3. The apparatus of dual monitor portable computer as set forth in claim 1, wherein said BIOS supports a shutdown mode, a multimedia mode, an operating system mode and other power save mode. (on or save, Which is better?)

4. The apparatus of dual monitor portable computer as set forth in claim 1, wherein said keyboard controller couples to said BIOS and said south bridge chipset via a LPC (Low-Pin-Count) bus.

5. The apparatus of dual monitor portable computer as set forth in claim 1, wherein said programmable logic controller couples to said BIOS and said south bridge chipset via LPC bus.

6. A means of operating an apparatus of dual monitor portable computer in a showdown mode, wherein a CPU of said portable computer is disable, comprising the steps of:
entering said shutdown mode;
powering up partial components through a keyboard controller;
accessing one or plurality of external devices, which are connected via an external device controller;
reading the system information of said portable computer via SMB (system management bus) by said keyboard controller;
displaying said system information on a secondary display monitor;
displaying a multi-functional menu on said secondary display monitor; and
executing the function of said multi-functional menu.

7. The means of operating said apparatus of dual monitor portable computer as set forth in claim 6, wherein said partial components powered up comprise at least said secondary display monitor, said external device controller and a audio amplifier.

8. The means of operating said apparatus of dual monitor portable computer as set forth in claim 6, wherein the step of accessing said external device by said keyboard controller is via a UART (Universal Asynchronous Receiver/Transmitter) interface.

9. The means of operating said apparatus of dual monitor portable computer as set forth in claim 6, wherein the function of said multi-functional menu is controlled by said hotkeys or a remote controller.

10. The means of operating said apparatus of dual monitor portable computer as set forth in claim 6, wherein said system information read via said SMB is at least comprising battery gauge, system thermal information.

11. The means of operating said apparatus of dual monitor portable computer as set forth in claim 6, wherein the options of said multi-functional menu have at least displaying time/date and battery status, music playing, multimedia mode and power off.

12. A means of operating an apparatus of dual monitor portable computer in a multimedia mode, wherein said portable computer is power on without executing OS, comprising the steps of:
entering a shutdown mode;
entering said multimedia mode, which is determined by choosing said multimedia mode displayed in a multi-functional menu of said shutdown mode;
powering up partial components through a keyboard controller;
disabling bus priority of a secondary display monitor;
acknowledging CPU and chipset to enter power save mode;
loading multimedia program from a multimedia memory unit;
displaying multimedia menu having plurality of multimedia functional options on said secondary display monitor; and
executing the function of said multimedia menu.

13. The means of operating said apparatus of dual monitor portable computer as set forth in claim 12, wherein said partial components powered up comprises at least said CPU, a north bridge chipset, a south bridge chipset and a programmable logic controller.

14. The means of operating said apparatus of dual monitor portable computer as set forth in claim 12, wherein said multimedia memory unit is a ROM which is configured distinctively from said BIOS.

15. The means of operating said apparatus of dual monitor portable computer as set forth in claim 12, wherein the function of said multimedia program is to display system information on said secondary display monitor by means of a programmable logic controller.

16. The means of operating said apparatus of dual monitor portable computer as set forth in claim 12, wherein the function of said multimedia menu is controlled by a remote controller and one or plurality of hotkeys.

17. The means of operating said apparatus of dual monitor portable computer as set forth in claim 16, wherein the step of entering said shutdown mode is controlled by operating one or plurality of hotkeys.

18. The means of operating said apparatus of dual monitor portable computer as set forth in claim 12, wherein the options of said multimedia menu have at least displaying time/date, battery status and system temperature, mode of playing picture, music playing, multimedia mode and power on/off.

19. An means of operating an apparatus of dual monitor portable computer in a OS (Operating System) mode, wherein said portable computer executes OS through normal boot up procedure, comprising the steps of:
entering said OS mode;
initializing a secondary display monitor;
executing boot up procedure of said computer system;
enabling said secondary display monitor;
displaying functional menu on said secondary display monitor; and
executing the function of said functional menu.

20. The means of operating said apparatus of dual monitor portable computer as set forth in claim 19, wherein after entering OS mode, there is a first display monitor differentiating an open lid mode and a close lid mode.
